(19) United States
(12) Patent Application Publication
(10) Pub. No.: US 2011/0205126 A1
(43) Pub. Date: Aug. 25, 2011

(54) Low-Profile Folded Dipole Antennas and Radio Communications Devices Employing Same

(75) Inventors: Katsunori Ishimiya, Tokyo (JP); Magnus Steijner, Loddekopinge (SE)

(73) Assignee: Sony Ericsson Mobile Communications AB

(21) Appl. No.: 12/712,782

(22) Filed: Feb. 25, 2010

(51) Int. Cl. H01Q 1/24; H01Q 9/26

(52) U.S. Cl. 343/702; 343/803

(57) ABSTRACT

An antenna system includes a folded loop radiator including a first loop portion conforming to a major surface of a planar substrate and an opposing second loop portion spaced apart from the planar substrate and including first and second ends electrically coupled to respective first and second ends of the first loop portion. The first and second loop portions may be disposed on the same side of the substrate or on opposite sides of the substrate.

### BACKGROUND OF THE INVENTION

The present application relates generally to antennas for radio communications devices and, more particularly, to internal antennas and communications terminals employing the same.

Portable radio communications devices, such as mobile terminals, media players, personal digital assistants and the like, commonly employ internal antennas, i.e., antennas that are integrated within a housing of the device to such support a thin, sleek appearance. One type of internal antenna is the folded dipole, which may be implemented using a folded loop structure with an unbalanced feed. Examples of folded dipole antennas are described, for example, in U.S. Pat. No. 7,605,764 to Ishimiya. While conventional internal antenna designs can support construction of thin devices, there is an ongoing need for techniques to provide even lower profile antenna structures.

### SUMMARY

In some embodiments of the present invention, an antenna system includes a folded loop radiator including a first loop portion conforming to a major surface of a planar substrate and an opposing second loop portion spaced apart from the planar substrate and including first and second ends electrically coupled to respective first and second ends of the first loop portion. The first and second loop portions may be disposed on the same side of the substrate or on opposite sides of the substrate.

The first loop portion may be configured to provide an antenna feed point, and the system may further include a ground plane conforming to the major surface of the substrate and coupled to the first loop portion. For example, the first loop portion may include a first conductor coupled to the ground plane and a second conductor configured to provide an antenna feed point. The first and second conductors and the ground plane may be formed from a common conductive layer.

In some embodiments, a first conductor member electrically connects the first ends of the first and second loop portions and a second conductor member electrically connects the second ends of the first and second loop portions. In other embodiments, a first contact assembly is configured to releasably electrically couple the first ends of the first and second loop portions and a second contact assembly is configured to releasably electrically couple the second ends of the first and second loop portions.

Further embodiments of the present invention provide a communications device including a housing, a radio communications circuit disposed within the housing, a planar substrate disposed within the housing and a folded loop radiator coupled to the radio communications circuit. The radiator includes a first loop portion conforming to a major surface of the planar substrate and an opposing second loop portion spaced apart from the planar substrate and including first and second ends electrically coupled to respective first and second ends of the first loop portion.

### BRIEF DESCRIPTION OF THE DRAWINGS

Other features of the present invention will be more readily understood from the following detailed description of specific embodiments thereof when read in conjunction with the accompanying drawings, in which:

FIGS. 1 and 2 are perspective views of antenna systems according to some embodiments of the present invention;

FIG. 3 is a perspective view of an alternative antenna configuration according to some embodiments of the present invention;

FIGS. 4 and 5 are perspective views of antenna systems according to still further embodiments of the present invention; and

FIG. 6 illustrates a profile of an antenna system according to some embodiments of the present invention in comparison to a conventional antenna system;

FIG. 7 is a block diagram of a communications device with an antenna system according to some embodiments of the present invention; and

FIG. 8 illustrates a communications device incorporating an integral antenna system according to further embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

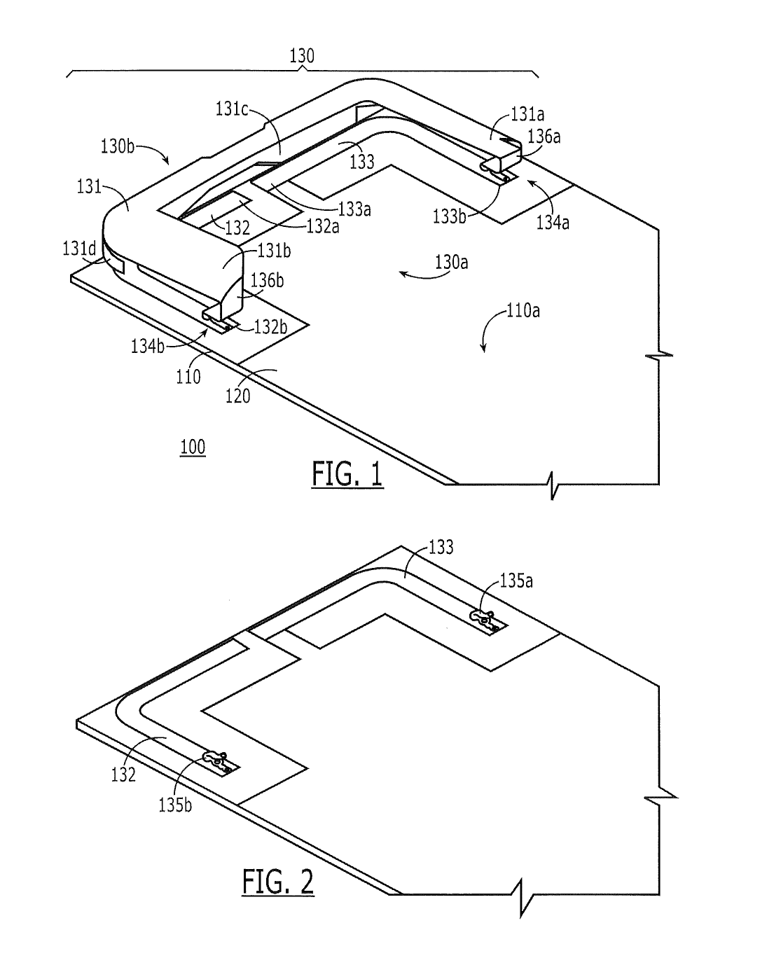

FIGS. 1 and 2 illustrate an antenna system 100 according to some embodiments of the present invention. The system 100 is supported by a planar substrate 110, e.g., a circuit card or board comprising a polyimide material and one or more layers of patterned conductive (e.g., metallization) layers that provide various wiring connections and shielding for one or more devices that may be mounted on the substrate 110. As shown, a conductive ground plane layer 120 is formed on a major surface 110a of the substrate 110, covering portions of the major surface of the substrate 110 except at regions at which a radiator 130 is formed. It will be appreciated that, in some embodiments, the ground plane 120 may be partially removed in other regions to allow for mounting and connection of other components (not shown), such as radio communications circuitry configured to be coupled to the antenna system 100.

The radiator 130 has a folded loop configuration including opposing first and second nominally planar loop portions 130a, 130b. The relative sizes of the first and second loop portions 130a, 130b may vary. The first loop portion 130a comprises first and second conductors 132, 133, which are formed directly on the major surface 110a of the substrate 110 and conform thereto. For example, in some embodiments, the first and second conductors 132, 133 may be formed by pattering the same conductive layer that is used to form the ground plane 120, or from a layer used to form some other wiring of the substrate 110. A first end 132a of the first conductor 132 is configured to provide an antenna feed point for the antennal system 100. A first end of the second conductor 133 is electrically coupled to the ground plane 120.

The second loop portion 130b is spaced apart from the substrate 110, at least partially overlapping the first loop portion 130a. The second loop portion 131 comprises a main member 131 having first and second ends 131a, 131b and from which a tab 131c extends towards the major surface of the substrate 110. Lateral tabs 131d extend perpendicularly from the tab 131c. The tabs 131c, 131d may be used to provide certain a certain frequency response for the antenna system 130, and may be eliminated in some embodiments. It will be appreciated that certain characteristics of the components of the first and second loop portions 130a, 130b, for example, the widths of the conductors 131, 132, 133 and the curvature of the bends thereof, may vary within the scope of the present invention. Structures, such as brackets, standoffs or intervening insulating material regions, may be used to maintain spacing between the second loop portion 130b and the surface 110a of the substrate.

The second loop portion 130b is electrically coupled to second ends 132b, 133b of the first and second conductors 132, 133 of the first loop portion 130a at ends 131a, 131b of the main member 131. In the illustrated embodiments, this coupling is provided by contact assemblies 134a, 134b, which comprise contacts 135a, 135b mounted on the first and second conductors 132, 133 of the first loop portion 130a and configured to releasably mate with contacts 136a, 136b attached to the main member 131 of the second loop portion 130b. It will be appreciated that the contacts 135a, 135b, 136a, 136b may be held together using any of a variety of mechanisms, such as by using a bracket or other structure to attach the second loop portion 130b to the substrate 110 and force the contacts 135a, 135b, 136a, 136b together to provide electrical coupling.

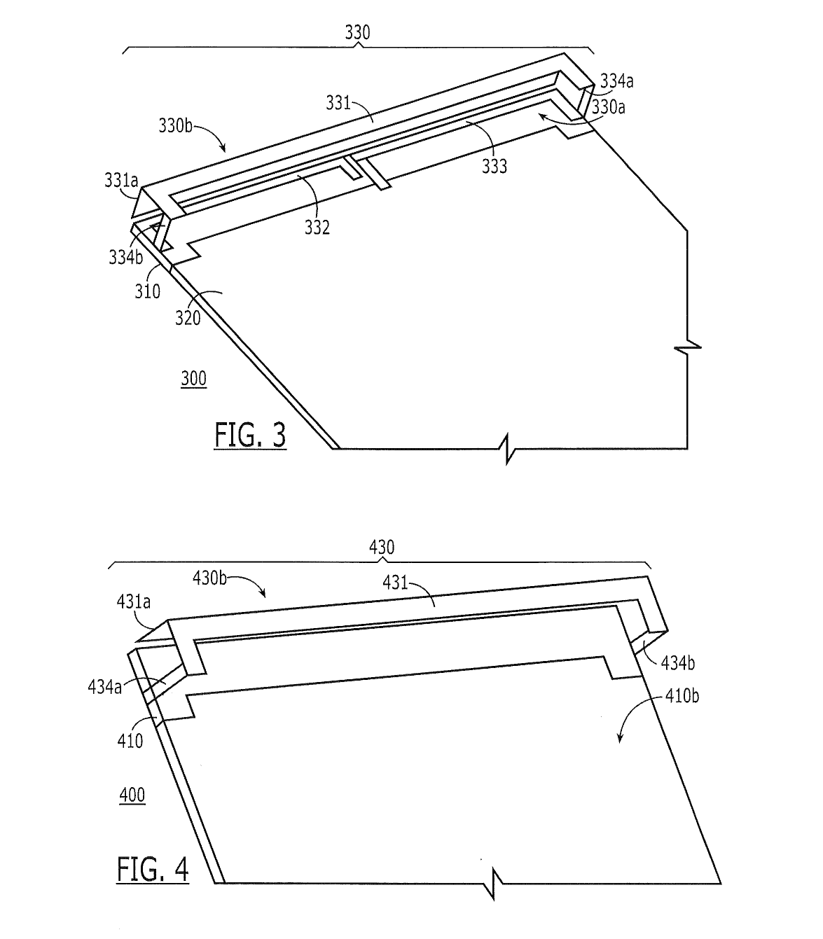

FIG. 3 illustrates an alternative configuration for an antenna system 300 according to further embodiments of the present invention. The antenna system 300 includes a radiator 330 formed on a substrate 310 on which a ground plane 320 is also formed. The radiator comprises first and second loop portions 330a, 330b. The first loop portion 330a includes first and second conductors 332, 333 that conform to a major surface 310a upon which the ground plane 320 is also formed. The second loop portion comprises a main member 331 with a tab 331a extending perpendicularly therefrom. The first and second loop portions are electrically coupled by first and second fixed conductors 334a, 334b, instead of using connector assemblies along the lines of the connector assemblies 134a, 134 b of the embodiments illustrated in FIGS. 1 and 2.

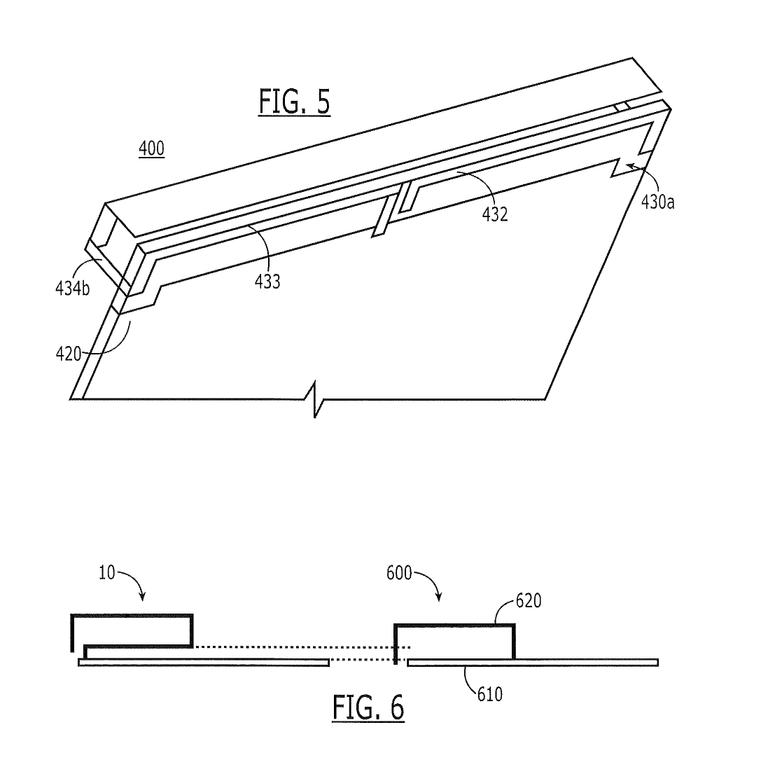

In further embodiments of the present invention, opposing loop portions of a folded loop radiator may be disposed on opposite sides of a supporting substrate. For example, as shown in FIGS. 4 and 5, an antenna system 400 may include a radiator 430 comprising a first loop portion 430a formed on a first side 410a of a substrate 410, upon which a ground plane 420 is also formed. The first loop portion 430a may comprise first and second conductors 432, 433 that conform to the surface 410a of the substrate 410 and which may be formed, for example, from the same layer used to form the ground plane 420. The first and second conductors 432, 433 may provide antenna feed and ground plane connections, respectively.

The radiator 430 may further include a second loop portion 430b disposed on a second side of the substrate 410, overlying and spaced apart from a second major surface 410b. The second loop portion 430b may include a main member 431 and a tab 431a extending perpendicularly therefrom. As shown, the first and second loop portions 430a, 430b are electrically coupled by fixed conductors 434a, 434b, but it will be appreciated that other structures may be used to connect the first and second loop portions 430a, 430b.

FIG. 6 illustrates potential advantages of an antenna system 600 according to some embodiments of the present invention in comparison to a conventional folded dipole antenna system 10, which may be constructed, for example, as described in U.S. Pat. No. 7,605,764 to Ishimiya. In particular, by forming a portion of a radiator 620 as a layer disposed on a substrate 610, the antenna system 600 may have a lower profile, which may allow a radio communications device employing the antenna system 600 to have a reduced profile as well.

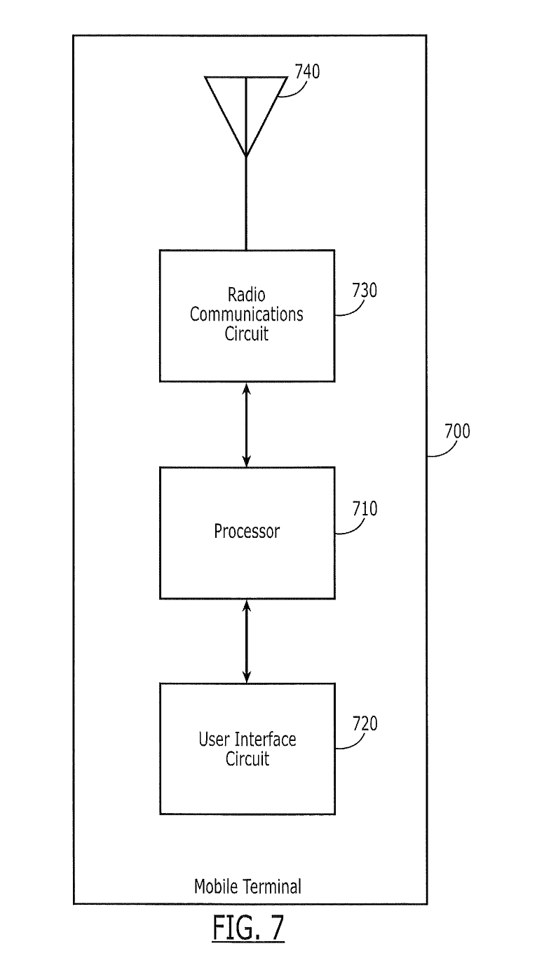

FIG. 7 illustrates a radio communications device, e.g. a mobile terminal 700, according to some embodiments of the present invention. The mobile terminal 700 includes a control processor 710, for example, a microprocessor, microcontroller or the like, which is operatively coupled to user interface circuitry 720 (e.g., keypad, microphone, speaker, display, etc.) and a radio communications circuit 730. The radio communications circuit 730 is configured to transmit and/or receive radio signals via an antenna system 740, which may be configured, for example, along the lines of the systems described above with reference to FIGS. 1-6. For example, for an antenna system 740 supported by a planar substrate such as the substrate 110 illustrated in FIGS. 1 and 2, all or some of the processor 710, the user interface circuitry 720 and/or the radio communications circuit 730 may be mechanically supported by the same substrate and connected to the antenna system 740 via circuit traces in and/or on the substrate.

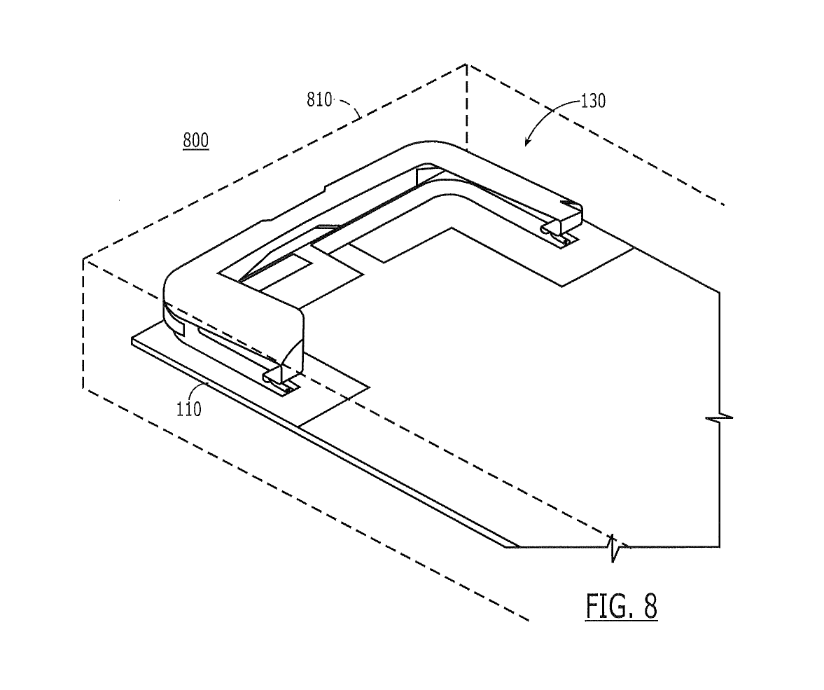

FIG. 8 illustrates an exemplary radio communications device 800 according to some embodiments of the present invention. The device 800 may be, for example, any of a number of types of devices having radio communications capabilities, including, but not limited to, mobile terminals (cell phones), hand-held computers, e-reader devices, personal digital assistants, media players and the like. The device 800 includes a housing 810 configured to hold components of the device 800, including, but not limited to, radio communications circuitry, a processor and user interface circuitry along the lines discussed above with reference to FIG. 7. As illustrated, an antenna system including a radiator 130 supported by a substrate 110 along the lines described above with reference to FIGS. 1 and 3 may be disposed within the housing 810. It will be appreciated that components of the radio communications circuitry and/or other circuitry of the device 800 may be supported by the substrate 110, with circuit traces thereof being used for connection between such circuitry and the radiator 130.

Many variations and modifications can be made to the embodiments without substantially departing from the principles of the present invention. All such variations and modifications are intended to be included herein within the scope of the present invention, as set forth in the following claims.

That which is claimed:

1. An antenna system comprising:
a folded loop radiator comprising a first loop portion conforming to a major surface of a planar substrate and an opposing second loop portion spaced apart from the planar substrate and comprising first and second ends electrically coupled to respective first and second ends of the first loop portion.

2. The antenna system of claim 1, further comprising a first conductor member electrically connecting the first ends of the first and second loop portions and a second conductor member electrically connecting the second ends of the first and second loop portions.

3. The antenna system of claim 1, further comprising a first contact assembly configured to releasably electrically couple the first ends of the first and second loop portions and a second contact assembly configured to releasably electrically couple the second ends of the first and second loop portions.

4. The antenna system of claim 1, wherein the first loop portion is configured to provide an antenna feed point.

5. The antenna system of claim 1, further comprising a ground plane conforming to the major surface of the substrate.

6. The antenna system of claim 5, wherein the first loop portion does not overlap the ground plane.

7. The antenna system of claim 5, wherein the first loop portion comprises a first conductor coupled to the ground plane and a second conductor configured to provide an antenna feed point.

8. The antenna system of claim 7, wherein the first and second conductors and the ground plane are formed from a common conductive layer.

9. The antenna system of claim 1, wherein the first and second loop portions are disposed on opposite sides of the planar substrate.

10. The antenna system of claim 1, wherein the first and second loop portions are disposed on the same side of the planar substrate.

11. A communications device, comprising:
a housing;
a radio communications circuit disposed within the housing;
a planar substrate disposed within the housing; and
a folded loop radiator coupled to the radio communications circuit and comprising a first loop portion conforming to a major surface of the planar substrate and an opposing second loop portion spaced apart from the planar substrate and comprising first and second ends electrically coupled to respective first and second ends of the first loop portion.

12. The device of claim 11, further comprising a first conductor member electrically connecting the first ends of the first and second loop portions and a second conductor member electrically connecting the second ends of the first and second loop portions.

13. The device of claim 11, further comprising a first contact assembly configured to releasably electrically couple the first ends of the first and second loop portions and a second contact assembly configured to releasably electrically couple the second ends of the first and second loop portions.

14. The device of claim 11, wherein the first loop portion is configured to provide an antenna feed point for connection to the radio communications circuit.

15. The device of claim 11, further comprising a ground plane conforming to the major surface of the substrate.

16. The device of claim 15, wherein the first loop portion does not overlap the ground plane.

17. The device of claim 15, wherein the first loop portion comprises a first conductor coupled to the ground plane and a second conductor configured to provide an antenna feed point.

18. The device of claim 17, wherein the first and second conductors and the ground plane are formed from a common conductive layer.

19. The device of claim 11, wherein the first and second loop portions are disposed on opposite sides of the planar substrate.

20. The device of claim 11, wherein the first and second loop portions are disposed on the same side of the planar substrate.
